(19) United States
(12) Patent Application Publication
(10) Pub. No.: US 2003/0104915 A1
(43) Pub. Date: Jun. 5, 2003

(54) Device for erecting flat folding box blanks or the like

(76) Inventors: Helmut Seidel, Walluf (DE); Bruno Jaksch, Wiesbaden (DE)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/240,448

(22) PCT Filed: Mar. 15, 2001
(86) PCT No.: PCT/DE01/00971

(30) Foreign Application Priority Data
Mar. 30, 2000 (DE) 10015761.0

(51) Int. Cl. B31B 1/78

(52) U.S. Cl. 493/309

(57) ABSTRACT

The invention relates to a device for erecting flat folding box blanks or the like that comprises a chase (34) and a form punch (33). When the form punch is introduced into the chase, the walls of the folding box blank (1), which is arranged between the form punch and the chase, are folded upward. When the walls are folded upward, the form punch and the chase are synchronously moved in a direction of conveyance of the folding box blanks. According to the invention, the form punch and the chase are each mounted in a crank mechanism (31, 32). A device of this type can be provided with a very simple structural design and can be economically produced. In addition, the device can be easily and quickly retrofitted.

### DESCRIPTION

The invention refers to a device for erecting flat folding box blanks or the like that comprises a chase and a form punch, whereby when the form punch is introduced into the chase, walls of the folding box blank, which is arranged between the form punch and the chase, are folded upward, and the form punch and the chase are synchronously moved in a direction of conveyance of the folding box blanks.

Such a device for erecting flat folding box blanks or the like is known from DE 43 22 224 C2. It is comprised of a chase designed more or less in U-shape, which is fastened to a chain conveyor and an upper form punch, which is introduced into the chase and fastened to an upper chain conveyor. The chase and the form punch are moved synchronously in a direction of conveyance, whereby the form punch is introduced into the chase, and the walls of the folding box are folded upward. The chain conveyor for the form punch is longer than the chain conveyor for the chase, and a conveyor belt is connected with the chase's chain conveyor. The form punch travels in the end area of the chase's chain conveyor, together with the erected folding box from the chase, whereby the unit thus generated continues on, and the erected folding box is detached from the form punch via ejectors located in the form punch, so that it drops onto the conveyor belt. The device for erecting folding boxes is specifically comprised of a large number of form punches, respectively chases, which are connected with each chain conveyor.

The form punches' and chases' layout on revolving chain conveyors is a disadvantage of the known device for erecting flat box blanks. As a result, an extensive length of conveyance is necessary, in which the punch's introductory movement into the assigned chase takes place, in order to erect folding box blanks. To do so precisely, special guide elements are required for the form punches and chases. The extensive length demands a high cost for the construction of the device. As it is necessary for economical reasons to equip the device with a large number of form punches and chases, retrofitting the device to other folding box formats involves considerable time and labor expenditures.

A device for feeding blanks into a packing machine's folding revolver is known from DE 37 38 102 A1. The form presses and chases are not moved synchronously but successively in a direction of conveyance. Only the form punches can be moved via a crank mechanism. The chases are arranged on the folding revolver, which is moving in increments.

A device for the automatic erection of packing blanks is known from DE 79 12 838 U1, where two form punches are provided and mounted in a shared rod. The rod's back-and-forth movement is accomplished with the help of a rocker, whose movement is actuated by means of a crank mechanism.

Another device for erecting folding boxes is known from EP 0 472 981, which also works according to the principle of revolving form punches and chases.

It is the task of the invention to further design a device of the aforementioned type in such a way that its structural design is very simple, it can be produced cost effectively and, in addition, can be retrofitted within a short period of time.

This task is solved with a device of the aforementioned type in that the form punch and the chase are each mounted in a crank mechanism, whereby the cranks of the crank mechanism are driven inversely in the direction of rotation.

The invention is therefore disassociated from the working principle of the devices described for erecting flat folding box blanks. Instead of a form punch, which is fastened to a chain conveyor, rotates with the chain conveyor and is mounted in the chase, which is also affixed to a rotating chain conveyor, the invention provides for a form punch and a chase, each mounted in a crank mechanism, whereby the cranks of the crank mechanism are driven inversely in direction of rotation. The working principle of the crank mechanism demands that the form punch and the chase move toward each other and away from each other as well as along a moving component in a direction of conveyance of the folding box blanks during the swiveling of the crank mechanism. During an individual crank's revolution, the form punch, respectively the chase, completes the movement segments leading to the form punch's introduction into the chase, further feeding in a direction of conveyance as well as retracting the form punch from the chase. Consequently, the folding box blank is reshaped for the purpose of erecting a folding box and the folding box blank, respectively the erected folding box, is transported simultaneously in a direction of conveyance, so that the continuous erection of folding boxes, which are fed in a direction of conveyance of a device according to the invention, is ahcieved by means of this working principle.

A specific advantage of a device according to the invention is notable in that it works using only one form punch and only one chase. Consequently, the device can be designed in a very compact manner, and the only requirement for retrofitting to other folding box formats is re-equipping one single form punch and one single chase. This provides a device according to the invention with a great advantage compared to the discussed current state of technology.

A specifically advantageous design of the invention features a revolving conveyor unit in order to convey folding box blanks to the device as well as to remove erected folding boxes. Therefore, each particular folding box blank need not be placed onto the chase, as the folding box blanks are transported by the revolving conveyor unit to the device for erecting folding box blanks.

One significant advantage is that merely one revolving conveyor unit is required. It is therefore used to convey folding box blanks to the erection device as well as to remove erected folding boxes. If, for instance, folding box blanks sit on guide rails while being conveyed to the erection device, conveyance, respectively movement of the folding box blanks is advantageously accomplished via carriers. For example, the conveyor unit is equipped with carriers for the folding box blanks, respectively erected folding boxes, specifically with carriers located immediately behind them. The rails on which folding box blanks, respectively erected folding boxes, are placed, are preferably guide rails for the revolving chains on which the carriers are mounted. In order for folding box blanks, respectively erected folding boxes, to be conveyed precisely, several rails arranged parallel to each other and equipped with chains as well as carriers should be provided. The blanks, respectively erected folding boxes, should sit on them with the better part of their width and specifically rest on the rails, if possible.

In addition, edge guides can be provided, specifically to guide folding box blanks edgewise, as a device according to the invention essentially depends on folding box blanks being conveyed dimensionally accurate to the working area of punch and chase.

According to a specific design example of the invention, it is provided that the conveyor unit runs through the area of the device for the erection of flat folding box blanks. The conveyor unit is therefore not interrupted and does not stop while a device according to the invention is in operation, that is, erecting a particular folding box. It is thus not necessary to operate the conveyor unit intermittently. For instance, it can be fashioned so that the chase exhibits a divided design, and the conveyor unit is guided between the chase sections. The chase is functionally designed in transverse projection to a direction of conveyance of the folding box blanks/erected folding boxes and is essentially U-shaped. The chase's U-shaped sections ensure that the bottom of a folding box as well as the walls of a folding box become a defined surface when erecting a folding box. The design of the invention therefore dispenses with the design of a box-shaped chase or the like, requiring only border areas necessary for holding and shaping individual sections of a particular folding box blank while chase and form punch operate concurrently.

The guides encompassing the bottom section of a blank are preferably also guided between the chase's sections.

In terms of the conveyor unit running through the device area in order to pick up flat folding box blanks, several functional ancillary conditions must be effectively realized. For example, the conveyance level of the rails picking up the blank and the conveyor unit should be located higher than the lowest level of the chase's upper end as well as lower than the highest level of the chase's upper end. This requires that the chase make contact and lift the folding box blank fed into its area only when being raised from its lowest position and that the folding box is erected by lifting the chase's upper end above the conveyance level of the conveyor unit. Thereby the form punch, which has meanwhile been lowered, is introduced into the chase. It is essential that the conveyance level of the conveyor unit, respectively the rails, is lower than the lowest level of the lower end of the punch. This ensures that the punch cannot make contact with the conveyor unit, respectively the rails.

According to a specific design of the invention, it is provided that the punch and chase are powered in such a way that they are arranged vertically during the crank mechanisms' full revolutions. Hypothetical vertical axes running through the punch and chase therefore run basically parallel. This process of movement is realized in an especially simple manner by designing the respective crank mechanism as a double rocker.

Based on the construction of a device according to the invention, the shaping process for erecting a particular folding box is therefore performed only via a particular crank mechanism's defined travel range. Folding the folding box blank upward is accomplished specifically via a particular crank mechanism's crank angle of about 50 to 70°. The folding box blank's forward stroke by means of the chase prior to the chase's and punch's concurrent operation is specifically accomplished via a crank angle of the crank mechanism associated with the chase of about 20 to 40°.

It is essential that the movements of punch, chase and conveyor unit are synchronized. If folding box blanks are deposited onto the conveyor unit via a rotary deposit unit, movement of the rotary deposit unit should be precisely tuned to movements of the form punch and chase as well as the conveyor unit. The use of servo drives is therefore specifically advantageous, in view of the fact that a folding box blank is taken off the conveyor unit along a curve due to crank geometry and is disconnected from the carrier with which it was thus far associated and which is therefore preferably trailing behind it. In order to continue the defined positioning of a folding box blank during this phase, the punch is comprised of one or more suction elements on its underside, specifically pneumatically effective suction elements. The raised folding box blank is therefore set up prior to erection by means of a form punch.

After erecting a folding box, it should be ascertained that it definitively disengages from the form punch as soon as it moves out of the chase. This is ensured by equipping the punch with one or more ejectors, specifically with mechanically effective ejectors, on its underside. By mechanically controlling the ejectors via mechanical components of the crank mechanism, an erected folding box can be directly released from the form punch, while form punch and chase move apart, respectively as the form punch leaves the chase, whereby the folding box is carefully placed on the conveyor unit, as the chase's upper end moves downward below the conveyor unit's level, and it is thus not dropped on top of it. This is an essential requirement in order for the folding box to continue conveyance in a precise manner.

In order to be able to easily retrofit the device for erecting flat folding box blanks to different folding box formats, the width of the conveyor unit and/or edge guides of the folding box blank, respectively the erected folding box, should be adjustable.

A folding box blank used with a device according to the invention is pre-folded specifically in the area of the folding edges. In addition, the chase is equipped with pre-drawn lines in order to be able to easily reshape the blank.

Additional characteristics of the invention can be found in the sub-claims, descriptions of the figures as well as the figures themselves, whereby it is noted that all characteristics and combinations of individual characteristics are designs of the invention.

The figures demonstrate the invention by means of embodiment examples without being limited to the embodiment. Shown are:

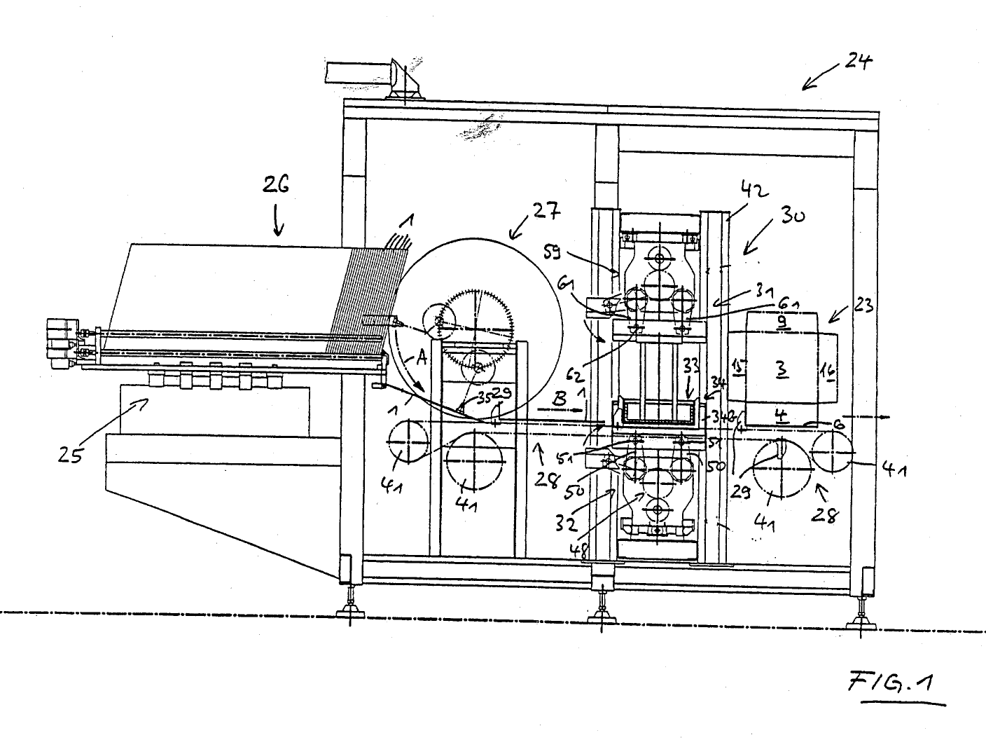

FIG. 1 complete view of a system exhibiting a device according to the invention for erecting flat folding box blanks or the like, seen in longitudinal section,

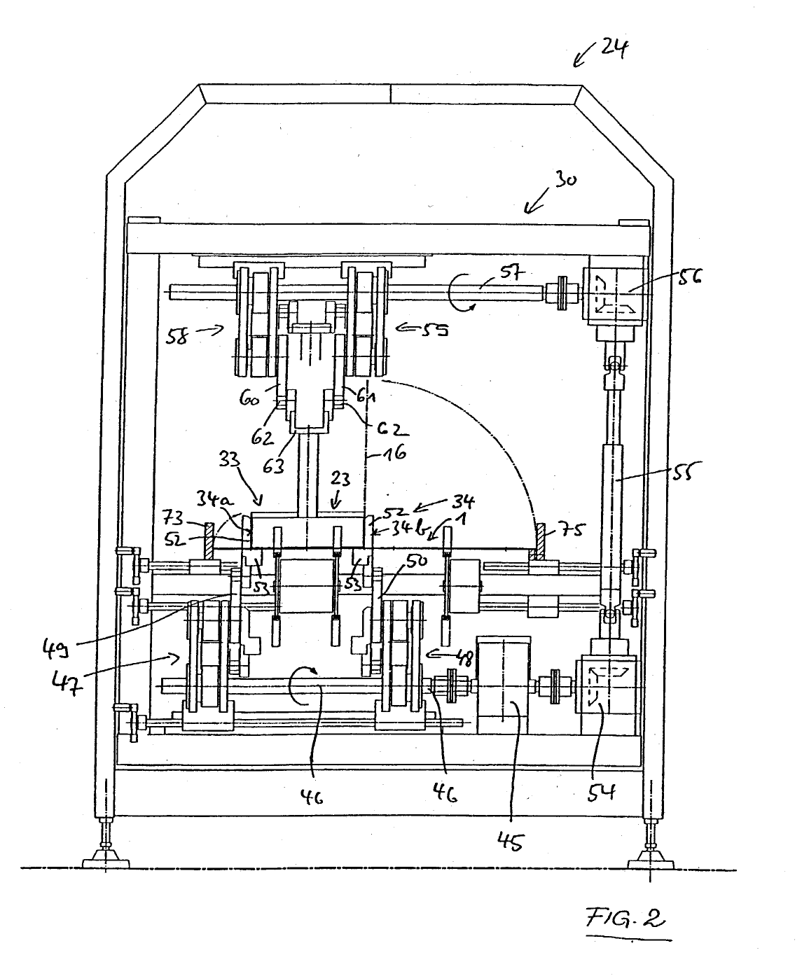

FIG. 2 cross section through the system in order to clarify the construction of a device according to the invention,

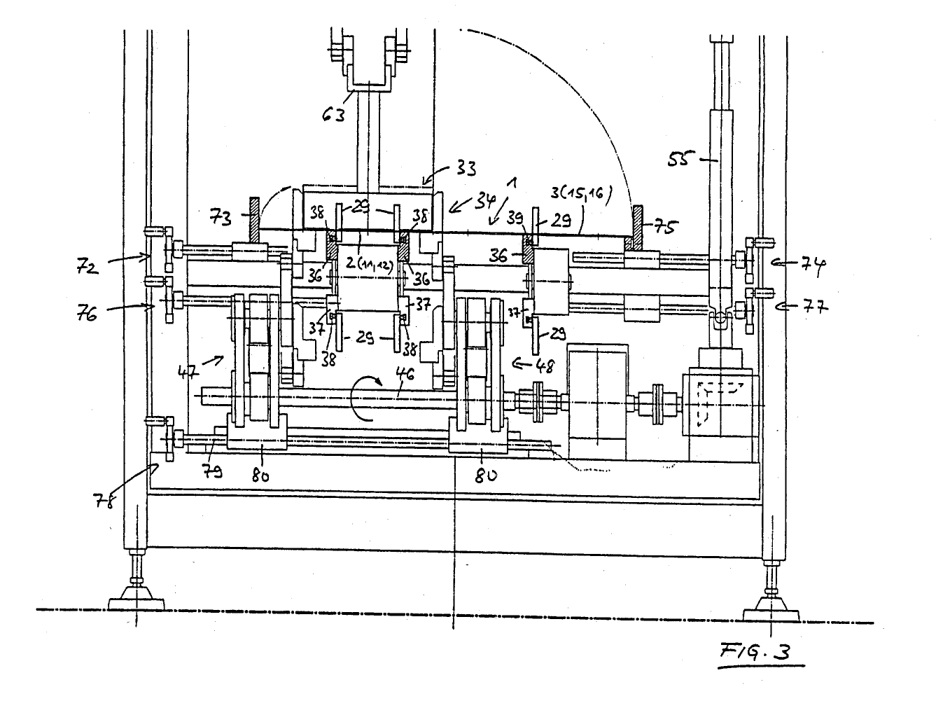

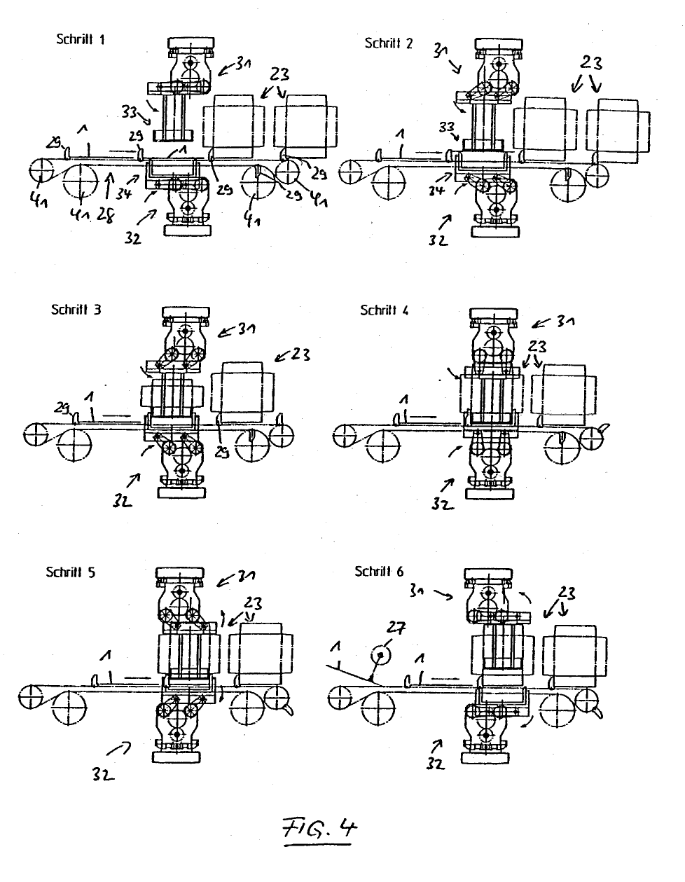

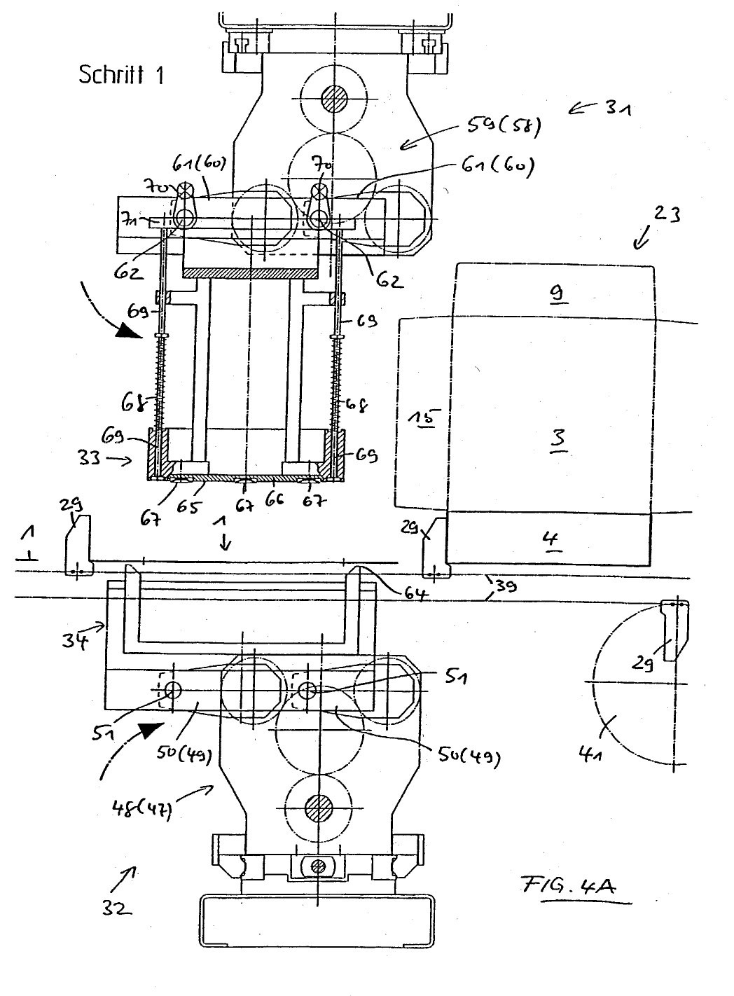

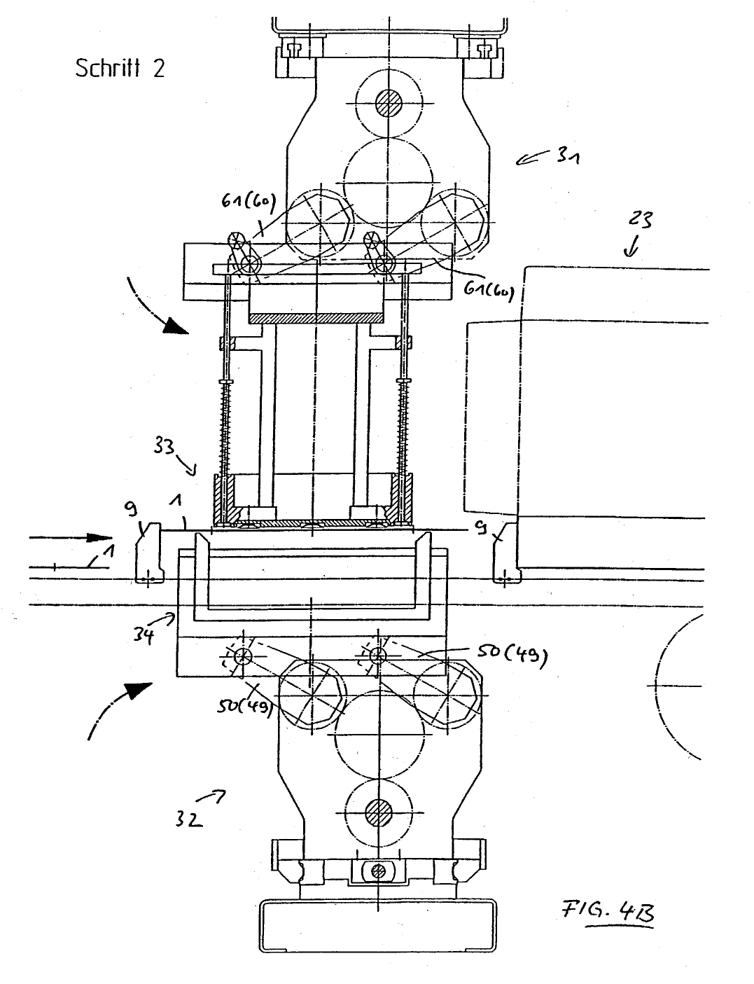

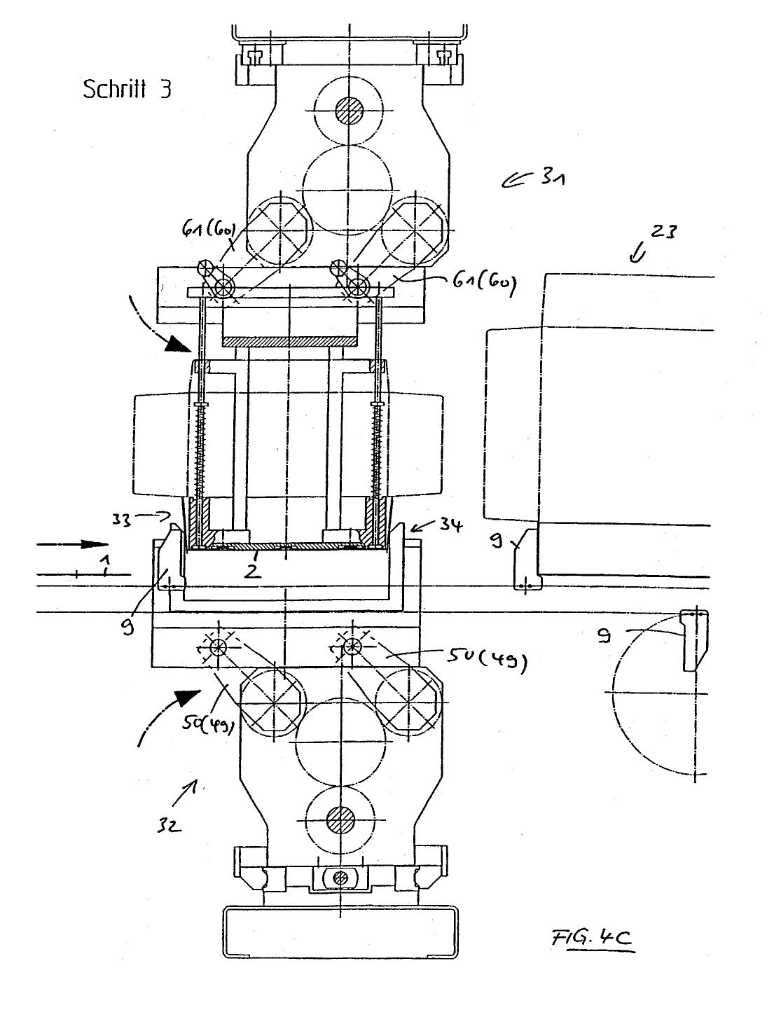

FIG. 3 detail of the device depicted in FIG. 2 with an additional illustration of adjustable features and drives,

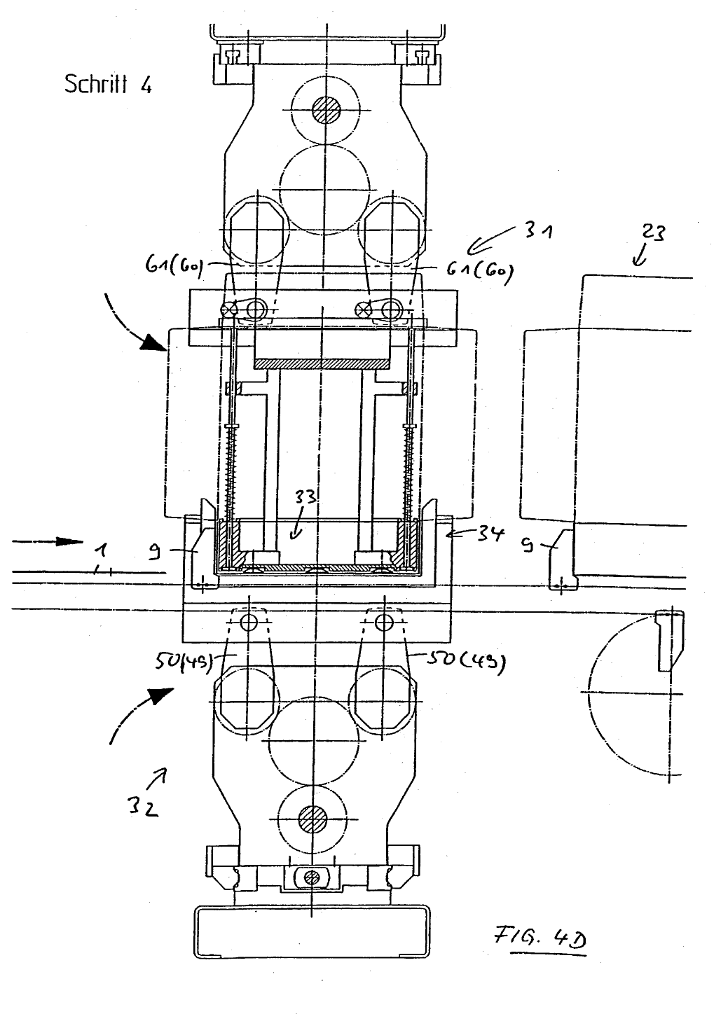

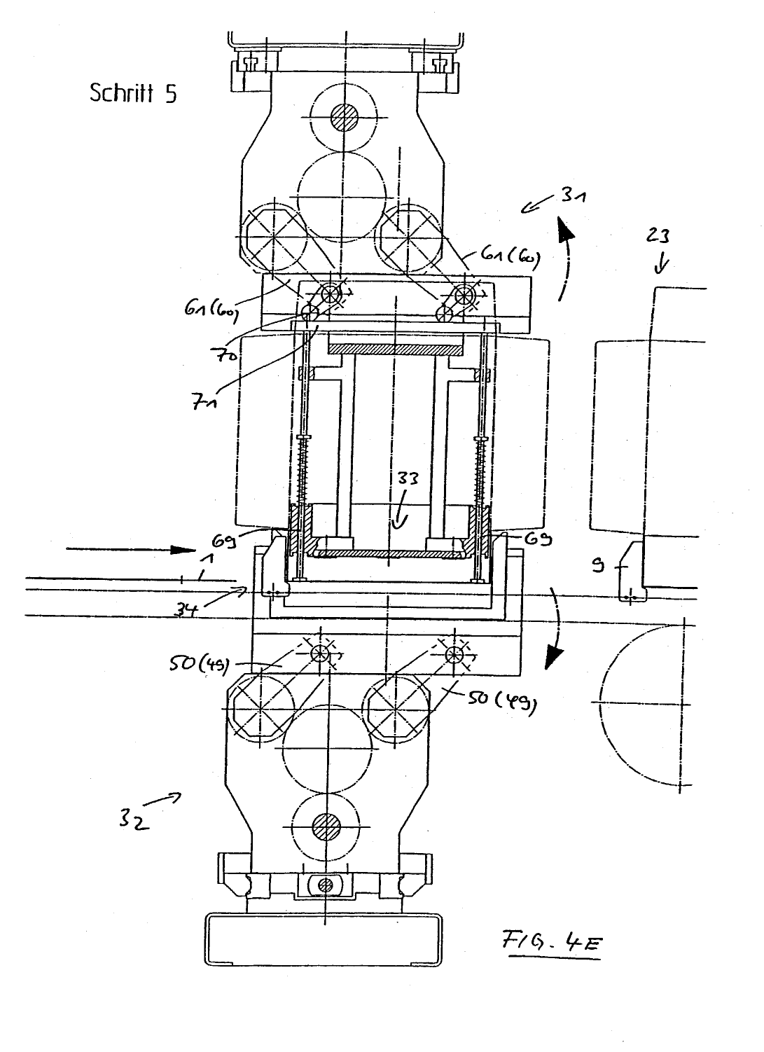

FIG. 4 six steps to clarify the progress of the erection process, illustrated in one overview,

FIGS. 4A to 4F individual steps shown in FIG. 4 in enlarged view, each illustrated for an area of a device according to the invention,

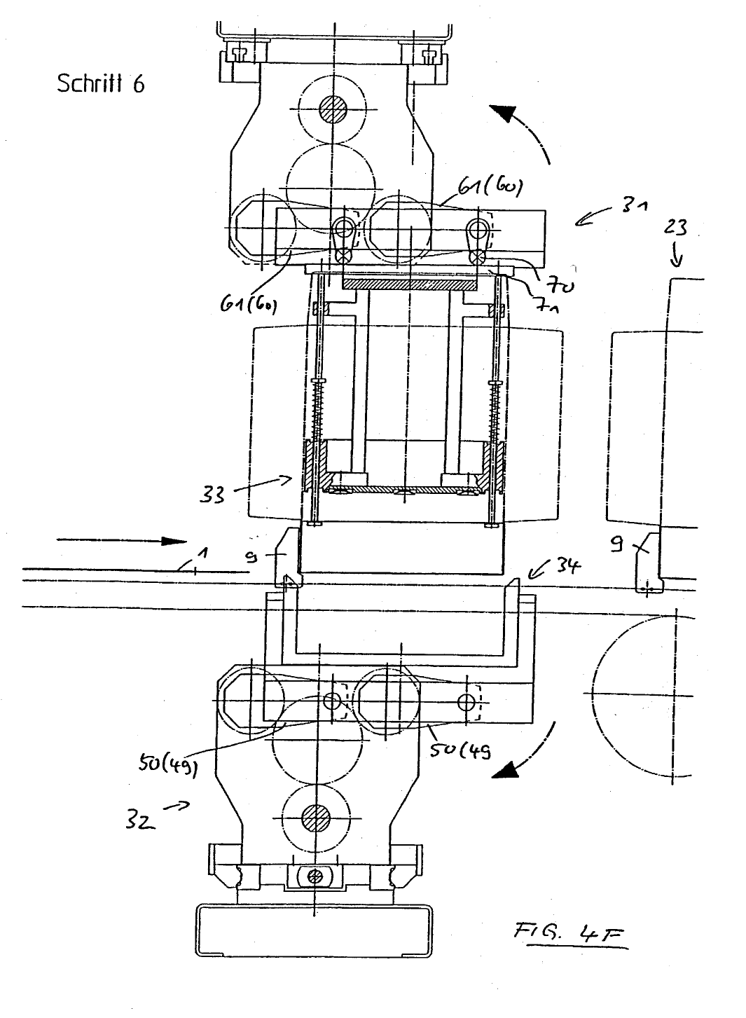

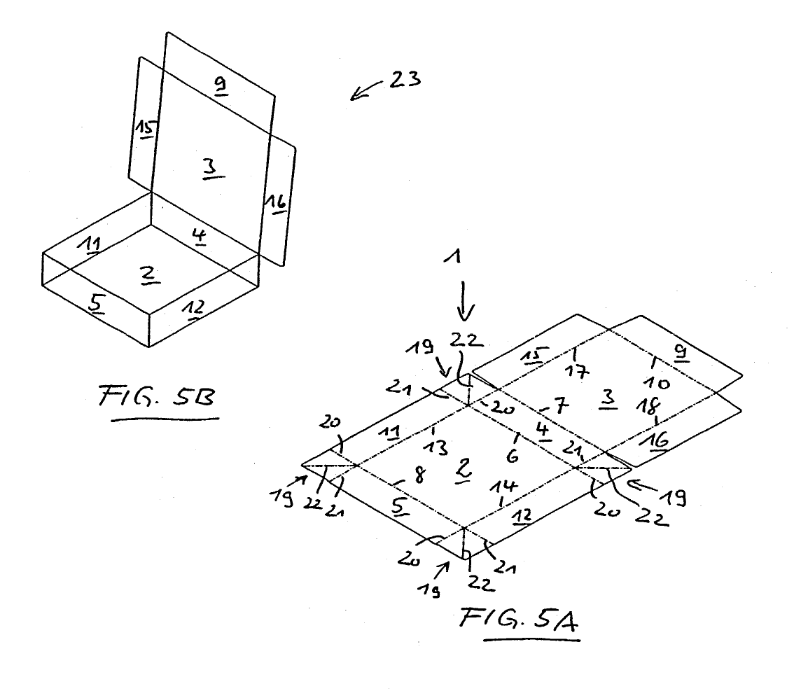

FIG. 5a spatial view of a folding box blank prior to erection

FIG. 5b spatial view of an erected folding box.

Folding box blank 1 to be erected by means of a device according to a design example is illustrated in FIG. 5a. A cuboid-shaped folding box is thus created. A one-piece blank made from carton is comprised of bottom section 1 and top section 3, whose main surfaces have the same dimensions and are square. A first side wall section 4 as well as a second side wall section 5 also have the same dimensions and are rectangular. The first side wall section 4 is connected with bottom section 2 and top section 3 via folding lines 6 and 7. The second side wall section 5 is connected with bottom section 2 via folding line 8. Flap section 9, which is designed in trapezoid shape, is connected with the top section via folding line 10. Rectangular front wall sections 11 and 12 are connected with bottom section 2 via folding lines 13 and 14. Two additional front flap sections 15 and 16 in trapezoid design are connected with top section 13 via folding lines 17 and 18.

In the area of the corners of bottom section 2, flaps 19 are connected with side wall section 5 and front wall section 12 via folding lines 20 and 21, respectively front wall section 12 and side wall section 4, respectively side wall section 4 and front wall section 11, respectively front wall section 11 and side wall section 5. Flaps 19 are each equipped with diagonal folding lines 22 beginning from the corners of bottom section 2. The carton is pre-folded in the area of the folding lines described for blank 1, that is the lines drawn with semicolons.

The design of folding box 23 erected according to the invention is derived from the illustration in FIG. 5b. Side wall sections 4 and 5 as well as front wall sections 11 and 12 are now oriented vertically to bottom section 2, whereby blank 1 has been reshaped in this area only. Top section 3, side wall section 9 as well as front wall sections 15 and 16 still form one level, which is essentially oriented vertically to the level of bottom section 2. Flaps 19 are folded inward.

The system shown in longitudinal section in FIG. 1 depicts the trailing structural components in rack 24, seen from left to right: long-term magazine 25 for a number of folding box blanks 1, arranged upstanding and forming blank stack 26, rotary deposit unit 27, which picks up the respective front blank 1 from blank stack 26 and feeds it to revolving conveyor unit 28 with carriers 29, depositing the blanks in horizontal position, erector group 30 with upper and lower crank mechanism 31, respectively 32, as well as form punch 33 picked up by upper crank mechanism 31 and chase 34 picked up by lower crank mechanism 32. Blank stack 26 is placed in long-term magazine 25 in such a manner that front wall sections 12 and 16 as well as flaps 19 associated with them point downward. When viewed in a direction of conveyance of blank 1, side wall section 9 points to the right. The respective blank 1 is seized by suction elements 35 of rotary deposit unit 27 and deposited counter-clockwise, in relation to the illustration of arrow A in FIG. 1, onto three upper chain guide rails 36, which are arranged horizontally and further illustrated in FIG. 3. Two of the guide rails 36 of the upper chain support bottom section 2 as well as front wall sections 11 and 12 connected with it, while the guide rail 36 of the third outer chain supports top section 3 as well as flap sections 15 and 16 connected with it. Chain guide rails 37 are located beneath chain guide rails 36.

The respective pair of chain guide rails 36 and 37 picks up revolving chain 39, on which carriers 29 are mounted. In relation to upper chain guide rails 36, carriers 29 protrude beyond the deposit level of folding box blank 1. Three carriers 29 each are arranged in a vertical line to the direction of conveyance of blank 1, so that a pair of carriers can make contact with front wall section 12, and the third carrier can make contact with flap section 16.

Folding box blank 1 linked to three carriers 29 each is moved by them relative to upper chain guide rails 37 in terms of arrow B in FIG. 1. The illustration also shows deflection rollers, respectively guide rollers 41, for chains 39 moving carriers 29. Only FIG. 3 shows chain guide rails 36 and 37, so that the position of folding box blank 1 can be exactly identified.

As can be seen specifically in the illustration of FIG. 1, rack 42 is mounted in machine rack 24 for erector group 30. It is comprised of upper crank mechanism 31 as well as lower crank mechanism 32, which is arranged beneath upper crank mechanism 31, above the level of conveyance of folding box blank 1. As can be seen specifically in the illustration of FIG. 2, both crank mechanisms 31 and 32 are powered by means of servo drive 45. It powers lower left crank mechanism 47 as well as lower right crank mechanism 48 via shaft 46. Each crank mechanism 47, respectively 48, synchronously drives two pivoting cranks 49, respectively 50. Both pairs of pivoting cranks serve as a bearing for chase 34 formed by parts 34a and 34b, whereby bearing axles 51 mounted in the vacant end area of pivoting cranks 49, respectively 50, serve as a bearing for chase part 34a in pivoting cranks 49, respectively for chase part 34b in pivoting cranks 50, which may pivot in relation to the bearing axles. Chase part 34a, respectively 34b, is comprised of a vertically oriented form section 52, which extends in direction of conveyance B, as well as another form section 53 located beneath, whereby the distance between both form sections 53 is less than the distance between both form sections 52.

The kinematics of form punch 33 are structured according to the kinematics of chase 34. However, the movement of servo drive 45 is first transferred via lower angular gear 54, intermediate shaft 55 and upper angular gear 56 to shaft 57 of the drive of form punch 33, comparable to shaft 46 of the drive of chase 34.

Shaft 57 drives the two crank drives 58 and 59, which in turn drive the four pivoting cranks 60 and 61, which pivot by means of bearing axles 62 and grasp pick-up plate 63, which is connected with form punch 33.

FIGS. 4 and 4A to 4F illustrate the mode of operation of erector group 30. For easier viewing, this mode of operation is illustrated in FIG. 4 in a sequence of steps from step 1 to 6, specifically in order to illustrate the machine's entire mode of operation, i.e. the area before and after erector group 30 with folding box sections 1 conveyed there, respectively erected folding boxes 23.

FIG. 4A shows the starting position, pivoting angle 0° of crank mechanisms 31 and 32. Folding box blank 1 to be erected sits on the guide rails 36 of the upper chain, which are not depicted (see FIG. 3). Three carriers 29 make contact with the trailing front edges of blank 1 and feed it into the starting position shown in FIG. 4A. Chase 34 is positioned slightly below folding box blank 1, in relation to the upper outline 64 of chase 34. The lower outline 65 of form punch 33 is positioned at a relatively significant distance to blank 1. This lower outline is generated by means of plate 66, into which suction elements 67 are integrated. Negative pressure connections leading to suction elements 67 are not shown. In the border area of plate 6, ejectors 69, which can be operated by means of cams 70 and are equipped with springs 68, are integrated in form punch 33. Cams 70 are tightly connected with pivoting cranks 60 and 61 and may be actively interconnected with holding plate 71 for ejectors 69. However, this occurs only after the folding box has been erected.

FIG. 4B shows erector group 30 while pivoting cranks 49, 50, respectively 60, 61, are at a pivoting angle of approx. 30°. Folding box blank 1, which is still flat, is lifted by chase 34. In this position, suction elements 67 of form punch 33 are put in operation. (For reasons of drawing clarity, blank 1 is drawn at a short distance to chase 34 and suction elements 67; in reality, these parts would have to make contact with blank 1.)

FIG. 4C shows erector group 30 at a pivoting angle of approx. 45°. The folding process is already under way, side wall sections 4 and 5 as well as front wall sections 11 and 12 are already almost entirely erect.

FIG. 4D illustrates the relationships at a pivoting angle of 90°. The folding process is complete, blank 1 has been completely erected.

FIG. 4E clarifies the relationships at a pivoting angle of 135°. Form punch 33 and chase 34 are retracting. Ejectors 69 push the carton downward out of form punch 33 and place erected folding box 23 carefully onto the two chain guide rails 36 associated with bottom section 2. Carrier 29 linked to erected folding box 23 abuts to its back. Instead of mechanically coupling ejectors 69 to the crank movement, a controlled ejector solution, which could be powered by means of a pneumatic cylinder, for example, would also be conceivable.

FIG. 4F shows the relationships at a pivoting angle of 180°. The erecting process has been finalized, and form punch 33 and chase 34 pivot onto their starting positions.

During the erecting process, carriers 29 are conveyed synchronously by the servo drive. After finalizing step 6 according to a pivoting angle of 180°, erected folding box 23 is fed out of the area of erector group 30, and a new folding box blank 1 is fed into erector group 30 simultaneously.

FIG. 3 specifically illustrates the diverse possibilities of modification in order to adjust the system to different dimensions of packing blanks 1. Adjustment feature 71 is provided for left edge guide 73 of blanks 1 and, accordingly, adjustment feature 74 for right edge guide 75 of blanks 1. Furthermore, width adjustment 76 for the conveyor unit, specifically for carriers 29 associated with the bottom section of blank 1, and adjustment feature 77 for carriers 29 supporting the top section of blank 1, are provided. Finally, width adjustment 78 is provided for lower crank mechanism 32. Width adjustment is done via adjusting spindle 79 on guide carriages 80 of crank mechanism 32.

1. A device for erecting flat folding box blanks or the like with a chase and a form punch, whereby when the form punch is introduced into the chase, walls of the folding box blank, which is arranged between the form punch and the chase, are folded upward and the form punch and the chase are synchronously moved in a direction of conveyance of the folding box blanks, specified in that form punch (33) and chase (34) are each mounted in a crank mechanism (31, 32), whereby cranks (49, 50, respectively 60, 61) of crank mechanisms (32, 31) are powered inversely in direction of rotation.

2. A device according to claim 1, characterized in that it is comprised of a single form punch (33) and a single chase (34) for erecting a folding box.

3. A device according to claim 1 or 2, characterized in that it is comprised of revolving conveyor unit (28) to move folding box blanks (1) to the device as well as to move erected folding boxes (23) away from it.

4. A device according to claim 3, characterized in that conveyor unit (28) is equipped with carriers (29) for folding box blanks (1), respectively erected folding boxes (23); specifically, that it is equipped with carriers (29) located directly behind them.

5. A device according to one of claims 3 or 4, characterized in that folding box blanks (1), respectively erected folding boxes (23) sit on rails (36), specifically on guide rails (36) for revolving chains (39), on which carriers (29) are mounted.

6. A device according to claim 5, characterized in that several rails (36) arranged parallel to each other and equipped with chains (39) and carriers (29) are provided.

7. A device according to one of claims 3 to 6, characterized in that conveyor unit (28) runs through the area of device (30) used to erect folding boxes.

8. A device according to one of claims 5 to 7, characterized in that the level of conveyance of rail (36) picking up folding box blank (1) is positioned higher than the lowest level of chase (34)'s upper end as well as that it is positioned lower than the highest level of chase (34)'s upper end.

9. A device according to one of claims 5 to 8, characterized in that the level of conveyance of rail (36) picking up folding box blank 1 is positioned lower than the lowest level of form punch (33)'s lower end.

10. A device according to one of claims 1 to 9, characterized in that chase (34) exhibits a divided design and that those elements of conveyor unit (28), which make contact with bottom section (2) of blank (1), run through parts (34a, 34b) of chase (34).

11. A device according to one of claims 1 to 10, characterized in that chase (34) exhibits a divided design and that rails (36) to hold bottom section (2) of folding box blank (1) pass between parts (34a, 34b) of chase (34).

12. A device according to one of claims 1 to 11, characterized in that chase (34) is designed essentially in U-shape in transverse projection to a direction of conveyance of folding box blanks (1)/erected folding boxes (23).

13. A device according to one of claims 1 to 12, characterized in that form punch (33) and chase (34) are arranged vertically during the entire revolution of crank mechanisms (31, 32).

14. A device according to one of claims 1 to 13, characterized in that folding box blanks (1) upwardly is accomplished via the respective crank mechanisms (31, 32)'s crank angle of 50 to 70°.

15. A device according to one of claims 1 to 14, characterized in that a forward stroke of folding box blank (1) is performed by means of chase (34) prior to the concurrent operation of chase (34) and form punch (33), specifically via a crank angle of 20 to 40° of crank mechanism (32) associated with chase (34).

16. A device according to one of claims 13 to 15, characterized in that the respective crank mechanism (31, 32) is designed as a double rocker (49, 50, 60, 61).

17. A device according to one of claims 1 to 16, characterized in that crank mechanisms (31, 32) and/or conveyor unit (2) can be powered by means of one or several servo drives (45).

18. A device according to one of claims 1 to 17, characterized in that form punch (33) is equipped on its underside with one or more suction elements (67), specifically with pneumatically effective suction elements.

19. A device according to one of claims 1 to 18, characterized in that form punch (33) is equipped on its underside with one or more ejectors (69), specifically with mechanically effective ejectors.

20. A device according to one of claims 1 to 19, characterized in that the width of conveyor unit (28) and/or edge guides (73, 75) of folding box blanks (1), respectively erected folding box (23) can be adjusted.
